(19) United States
(12) Patent Application Publication
(10) Pub. No.: US 2008/0074499 A1
(43) Pub. Date: Mar. 27, 2008

(54) IMAGE PROCESSING APPARATUS, IMAGE CAPTURE APPARATUS, CONTROL METHOD THEREFOR, AND COMPUTER PROGRAM

(75) Inventor: Ikuo Niimura, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/857,145

(22) Filed: Sep. 18, 2007

(30) Foreign Application Priority Data
Sep. 22, 2006 (JP) 2006-257736

(51) Int. Cl. H04N 5/225

(52) U.S. Cl. 348/207.1

(57) ABSTRACT

An image processing apparatus comprising, an image capture unit configured to execute image capturing in response to an image shooting instruction, a display unit configured to display an image obtained by the image capturing, a transfer instruction acceptance unit configured to accept a transfer instruction to transfer the image to an external apparatus, a communication unit configured to transfer an image subject to the transfer instruction to the external apparatus, and a display control unit configured to control display by the display unit, that, if acceptance of the transfer instruction by the transfer instruction acceptance unit is possible during display of the image by the display unit, controls the display unit so as to continue displaying the image until the transfer instruction is accepted.

### BACKGROUND OF THE INVENTION

1. Field of the Invention

The present invention relates to an image processing apparatus, an image capture apparatus, a control method therefor, and a computer program.

2. Description of the Related Art

An image capture apparatus such as a digital camera is able to convert an optical image generated by an image capture device such as a CCD or a CMOS to an electrical signal, and record the electrical signal as a digital image to a removable recording medium such as CompactFlash®, an SD card or a hard disk, or to a fixed recording medium. Digital cameras are advantageous in that photos can be taken without worrying about the number of shots taken, unlike silver halide cameras that use film. Also, more and more digital still cameras are able to transfer captured image data by communication such as wired or wireless LAN to an external apparatus such as a personal computer or a network hard disk using built-in or external connection accessories (see Japanese Patent Laid-Open No. 2000-330853).

Image transfer modes available in current digital cameras include the following. Firstly, there is a mode in which all image data captured by the digital still camera is judged to be for transfer, and transferred to an external apparatus using communication. There is also a mode in which image data already recorded on a recording medium is selected for transfer using a display member such as a TFT screen and an operation member of the digital camera body, or by collating with a fixed condition such as the date. Further, there is a transfer mode in which the image is displayed on a TFT screen immediately after being captured, together with a menu prompting the user to decide whether to transfer the image to an external apparatus by communication, with communication then being performed based on the user's decision.

However, in the case of the mode in which all captured images are automatically transferred to an external apparatus, blurred images, out-of-focus images, and images that are not well-composed contrary to the photographer's intentions are automatically transferred to the transfer destination.

When unnecessary image data is thus transferred, desired image data gets processed after the unnecessary image data has been communicated, thereby delaying transfer to the image transfer destination. The transfer of unnecessary image data is also wasteful in the sense that the recording medium of the external apparatus to which the image data is communicated is naturally limited in terms of recording capacity.

Also, the transfer method in which an image is displayed on a TFT screen immediately after being taken, and a screen prompting the user to decide whether or not to send the image is further displayed on the TFT screen does not work effectively if the duration of the TFT display is short.

Thus, it is difficult to reliably select desired images and transfer only selected images without transferring unnecessary data.

### SUMMARY OF THE INVENTION

Embodiments, features and aspects of the present invention are provided to allow desired images to be reliably selected and only selected images to be transferred without transferring unnecessary data.

According to one aspect of the present invention, an embodiment is directed to an image processing apparatus comprising, an image capture unit configured to execute image capturing in response to an image shooting instruction, a display unit configured to display an image obtained by the image capturing, a transfer instruction acceptance unit configured to accept a transfer instruction to transfer the image to an external apparatus, a communication unit configured to transfer an image subject to the transfer instruction to the external apparatus, and a display control unit configured to control display by the display unit, that, if acceptance of the transfer instruction by the transfer instruction acceptance unit is possible during display of the image by the display unit, controls the display unit so as to continue displaying the image until the transfer instruction is accepted.

According to another aspect of the present invention, an embodiment is directed to an image capture apparatus comprising, an image capture unit configured to execute image capturing, a display unit configured to display an image obtained by the image capturing, a setting unit configured to set a display time for every images obtained by the image capturing, a communication unit configured to transfer the image obtained by the image capturing to an external apparatus, and a display control unit configured to control display by the display unit so as to continue displaying the image until a following operation is accepted by ignoring the display time set by the setting unit, if it had been instructed to confirm the image to be transferred before transferring.

Further features and aspects of the present invention will become apparent from the following description of exemplary embodiments with reference to the attached drawings.

### BRIEF DESCRIPTION OF THE DRAWINGS

FIG. 1 shows an example configuration of an image processing apparatus according to an exemplary embodiment of the present invention.

FIG. 2A is a flowchart illustrating exemplary processing according to an exemplary embodiment of the present invention.

FIG. 2B is a flowchart illustrating exemplary processing according to an exemplary embodiment of the present invention.

FIG. 3 is a flowchart illustrating exemplary processing in a Quick Review Image Select/Transfer mode according to an exemplary embodiment of the present invention.

FIGS. 4A through 4D show an exemplary screen for setting the image transfer mode according to an exemplary embodiment of the present invention.

FIGS. 5A and 5B illustrate processing in shooting modes according to an exemplary embodiment of the present invention.

FIGS. 6A and 6B show exemplary Quick Review displays in the shooting modes according to an exemplary embodiment of the present invention.

FIGS. 7A and 7B illustrate the changeover of Quick Review displays according to an exemplary embodiment of the present invention.

FIGS. 8A and 8B illustrate an example process for selecting an image for transfer from a plurality of images displayed in Quick Review according to an exemplary embodiment of the present invention.

FIG. 9 is a flowchart illustrating an example focusing and metering process according to an exemplary embodiment of the present invention.

FIG. 10 is a flowchart showing an example image capturing process according to an exemplary embodiment of the present invention.

### DESCRIPTION OF THE EMBODIMENTS

Hereinafter, various embodiments, features and aspects of the present invention will now herein be described with reference to the accompanying drawings.

### First Exemplary Embodiment

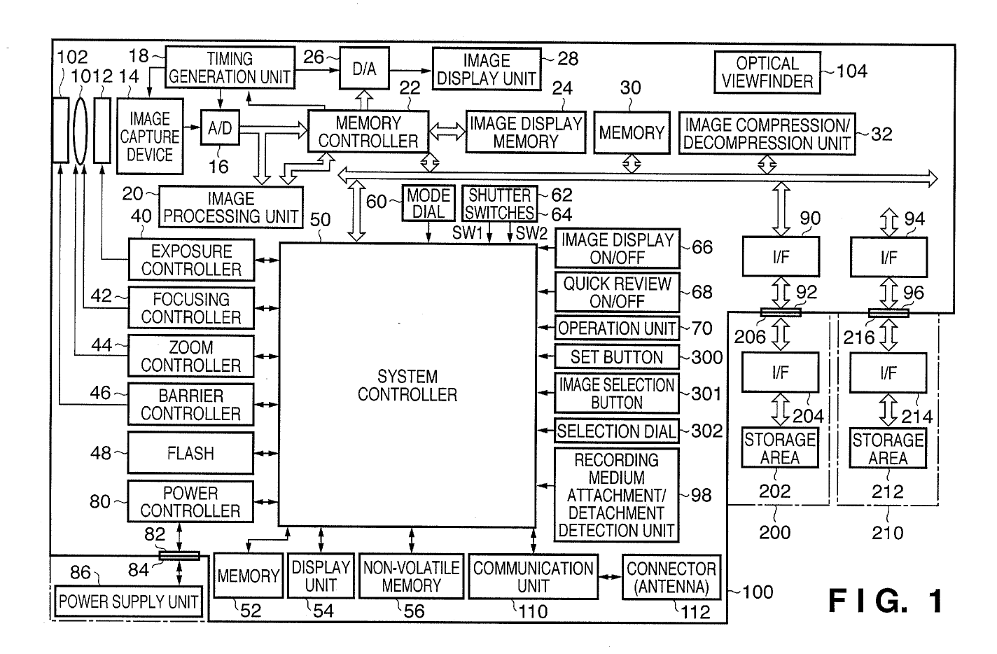

FIG. 1 shows the configuration of an embodiment of the present invention. In FIG. 1, reference numeral 100 denotes an image processing apparatus according to the present embodiment. The image processing apparatus 100 can be implemented as a digital camera, for example. The image processing apparatus 100 can also be realized as a personal computer, a mobile telephone, a PDA or the like having a photographic function.

In the image processing apparatus 100, reference numeral 10 denotes a photographing lens; 12, a shutter with an aperture function; 14, an image capture device that converts an optical image to an electrical signal; and 16, an A/D converter that converts the analog signal output of the image capture device 14 to a digital signal. Reference numeral 18 denotes a timing generation unit that supplies a clock signal and a control signal to the image capture device 14, the A/D converter 16, and a D/A converter 26, and is controlled by a memory controller 22 and a system controller 50.

Reference numeral 20 denotes an image processing unit that performs predetermined pixel interpolation and color conversion on data from the A/D converter 16 or data from the memory controller 22. The image processing unit 20 also performs predetermined arithmetic processing using image data obtained by image capturing. The system controller 50 performs through-the-lens (TTL) auto focus (AF), auto exposure (AE) and electronic flash pre-emission (EF) by controlling an exposure controller 40 and a focusing controller 42 based on the results obtained from the arithmetic processing.

Further, the image processing unit 20 performs predetermined arithmetic processing using image data obtained by image capturing, and performs TTL auto white balance (AWB) based on the results obtained from the arithmetic processing.

Reference numeral 22 denotes a memory controller that controls the A/D converter 16, the timing generation unit 18, the image processing unit 20, an image display memory 24, the D/A converter 26, a memory 30, and an image compression/decompression unit 32. Data from the A/D converter 16 is written to the image display memory 24 or the memory 30 via the image processing unit 20 and the memory controller 22 or directly via the memory controller 22.

Reference numeral 24 denotes an image display memory; 26, a D/A converter; and 28, an image display unit composed of a TFT LCD or the like. Image data for display written in the image display memory 24 is displayed by the image display unit 28 via the D/A converter 26. An electronic viewfinder function can be realized by using the image display unit 28 to sequentially display image data obtained by image capturing. The image display unit 28 is able to arbitrarily turn the display on and off in response to an instruction from the system controller 50. The power consumption of the image processing apparatus 100 can be greatly reduced by turning the display off.

Reference numeral 30 denotes a memory for storing captured still images and moving images, and is provided with sufficient storage capacity to store a predetermined number of still images or a predetermined number of hours of moving images. A large volume of image data can thereby be written to the memory 30 at high speed, even in the case of panorama shooting or continuous shooting whereby a plurality of still images are taken sequentially. The memory 30 can also be used as the work area of the system controller 50.

Reference numeral 32 denotes a compression/decompression unit that compresses or decompresses image data using adaptive discrete cosine transform (ADCT) or the like. The image compression/decompression unit 32 reads images stored in the memory 30, compresses or decompresses the read images, and writes the processed data to the memory 30.

Reference numeral 40 denotes an exposure controller that controls the shutter 12 that has the aperture function. The exposure controller 40 also provides a flash brightness control function in conjunction with a flash 48. Reference numeral 42 denotes a focusing controller that controls the focusing of the photographing lens 10; 44, a zoom controller that controls the zooming of the photographing lens 10; and 46, a barrier controller that controls the operations of a barrier 102. Reference numeral 48 denotes a flash that has an AF assist light emission function and a flash brightness control function.

The exposure controller 40 and the focusing controller 42 are controlled using the TTL system, and the system controller 50 controls the exposure controller 40 and the focusing controller 42 based on the results obtained from the arithmetic processing performed by the image processing unit 20 on image data obtained by image capturing. Reference numeral 50 denotes a system controller that controls the entire image processing apparatus 100; and 52, a memory that stores constants, variables, and computer programs used in the operations of the system controller 50.

Reference numeral 54 denotes a display unit composed of a liquid crystal display, a speaker and the like that displays operational status, messages and the like using text, images, audio and the like in response to the execution of computer programs by the system controller 50. The display unit 54, which is constituted, for example, by a combination of an LCD, an LED and a sound emitting element is installed in one or more readily viewable locations in a vicinity of the operation units of the image processing apparatus 100.

Some of the functions of the display unit 54 are installed in an optical viewfinder 104. Display content of the display unit 54 that is displayed on an LCD or the like includes switching between single frame shooting and continuous shooting, a self-timer, compression ratio, number of recording pixels, number of recorded images, remaining number of recordable images, shutter speed, aperture value, exposure compensation, flash, red-eye reduction, macro, buzzer setting, remaining clock battery power, remaining camera battery power, error, multi-digit number information display, attachment/detachment of recording media 200 and 210, communication interface operation, and date and time. Display content of the display unit 54 that is displayed on the optical viewfinder 104 includes focusing, camera-shake warning, flash charging, shutter speed, aperture value, and exposure compensation. Reference numeral 56 denotes an electrically erasable/recordable nonvolatile memory such as an EEPROM, for example.

Reference numerals 60, 62, 64, 66, 68 and 70 denote operation units for inputting the various operation instructions of the system controller 50, and are constituted by a combination of one or more of a switch, a dial, a touch panel, a pointing device using line-of-sight detection, a voice recognition apparatus, and the like. The operation units will be described in detail hereinafter.

Reference numeral 60 denotes a mode dial that is able to switch between various function modes, including shut down, auto shooting mode, shooting mode, panorama mode, playback mode, multi-frame playback and erase mode, and PC connection mode.

Reference numeral 62 denotes a shutter switch SW1 that is turned on by operating the shutter button (not shown) partway, and that issues an instruction to start processes such as auto focus (AF), auto exposure (AE), auto white balance (AWB), and electronic flash pre-emission (EF).

Reference numeral 64 denotes a shutter switch SW2 that is turned on by operating the shutter button (not shown) fully, and that issues an instruction to start the following series of processes. The series of processes includes an exposure process in which a signal read from the image capture device 14 is written to the memory 30 as image data via the A/D converter 16 and the memory controller 22, a developing process that uses arithmetic processing performed by the image processing unit 20 and the memory controller 22, and a recording process in which image data is read from the memory 30, compressed with the image compression/decompression unit 32, and written to the recording medium 200 or 210.

Reference numeral 66 denotes an image display ON/OFF switch that is able to turn the image display unit 28 on or off. The function enables power saving to be realized by cutting off the supply of current to the image display unit, which is composed of a TFT LCD or the like, when capturing an image using the optical viewfinder 104.

Reference numeral 68 denotes a Quick Review ON/OFF switch that sets a Quick Review function for automatically playing image data immediately after the image data is captured. Note that according to the present embodiment, in particular, the Quick Review ON/OFF switch 68 is provided with a function to set the Quick Review function when the image display unit 28 is off.

Reference numeral 300 denotes a button capable of being allocated a camera function (hereinafter, SET button). The allocated function is turned on by pressing the SET button. For example, if the user wants to quickly display one of the setting menus on the TFT screen, the desired menu will be immediately displayed when the SET button is pressed, by allocating the display function of the menu as the allocated function of the SET button. According to the present invention, the SET button is used for deciding whether to select an image displayed in Quick Review for transfer to a personal computer or the like via the communication function of the camera. The image displayed in Quick Review when the SET button is pressed is selected for transfer, and the transfer process is performed.

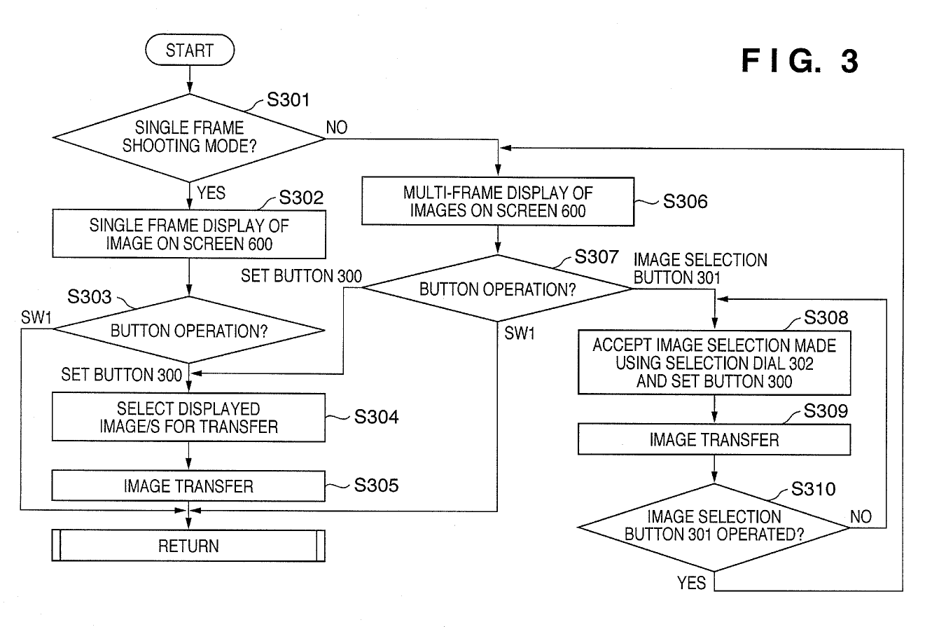

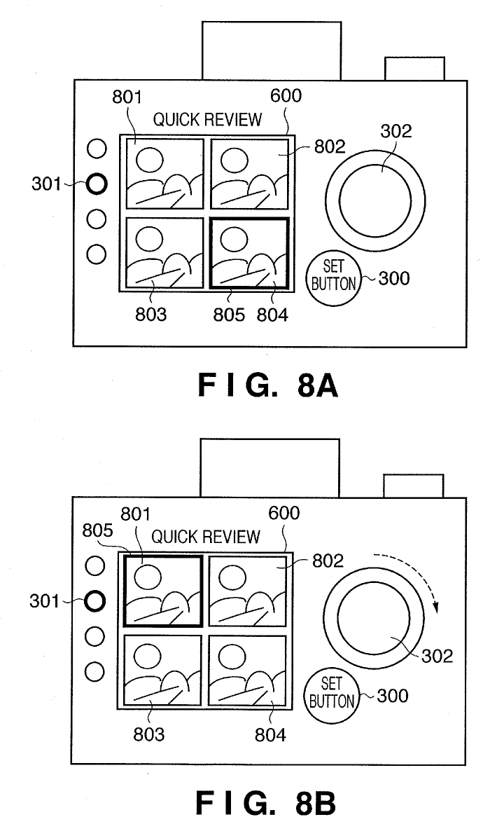

Reference numeral 301 denotes an image selection button. Image selection mode is enabled when the button is pressed, and it is possible to focus in on images currently being displayed on the TFT screen by rotating a selection dial 302. A detailed description will follow hereinafter, with reference to FIGS. 3, 8A, and 8B.

Reference numeral 70 denotes an operation unit composed of various buttons, a touch panel and the like. For example, the operation unit 70 includes a menu button, a macro button, a multi-frame playback new page button, a flash setting button, a signal shot/continuous shooting/self-timer switching button, a next menu (+) button, a previous menu (−) button, a show next image (+) button, a show previous image (−) button, an image quality selection button, an exposure compensation button, a date/time setting button, and a bracket shooting mode selection button. Note that bracket shooting mode indicates a shooting mode in which a plurality of images are taken while changing settings such as exposure (AE), white balance (WB), manual focus (MF), and flash emission amount with each frame.

Reference numeral 80 denotes a power controller that is constituted by a battery detection unit, a DC-DC converter, and a switching unit that switches the blocks that are energized. The power controller 80 detects battery installation, battery type and remaining battery power, controls the DC-DC converter based on the detection results and instructions from the system controller 50, and supplies a required voltage to the components including recording media for the required amount of time.

Reference numeral 82 denotes a connector; 84, a connector; and 86, a power supply unit composed of a primary battery such as an alkaline or lithium ion battery, a secondary battery such as an NiCd, NiMH or Li battery, and an AC adaptor. Reference numerals 90 and 94 denote interfaces with recording media such as a memory card or a hard disk. Reference numerals 92 and 96 denote connectors for connecting to recording media such as a memory card or a hard disk. Reference numeral 98 denotes a recording medium attachment/detachment detection unit that detects whether the recording medium 200 or 210 are connected to the connectors 92 and/or 96.

Note that the present embodiment is described as having two systems of interfaces and connectors for attaching recording media. Naturally, there may be any number of systems of interfaces and connectors for attaching recording media, whether one or a plurality thereof. Interfaces and connectors complying with different standards may as also be combined. It is possible to use interfaces and connectors that comply with the standards for PCMCIA cards, CompactFlash (CF®) cards, or the like.

Further, consider the case where the interfaces 90 and 94 and the connectors 92 and 96 comply with the standards for PCMCIA cards, CompactFlash cards or the like. In such a circumstance, image data and management information attached to image data can be transferred to and from a peripheral device such as another computer or a printer by connecting any of a variety of communication cards. Note that communication cards referred to here include LAN cards, modem cards, USB cards, IEEE 1394 cards, P1284 cards, SCSI cards, and PHS cards.

Reference numeral 102 denotes a barrier that prevents an image capture unit which includes the lens 10 of the image processing apparatus 100 from being soiled or damaged by covering the image capture unit. Reference numeral 104 denotes an optical viewfinder. Images can be taken using only the optical viewfinder, without using the electronic viewfinder function provided by the image display unit 28. Some of the functions of the display unit 54 are installed in the optical viewfinder 104, including, for example, focusing display, camera-shake warning display, flash charging display, shutter speed display, aperture value display, and exposure compensation display.

Reference numeral 110 denotes a communication unit that has various communication functions such as RS-232C, USB, IEEE 1394, P1284, SCSI, modem, LAN and wireless communication. Reference numeral 112 denotes a connector for connecting the image processing apparatus 100 to another device using the communication unit 110, or an antenna in the case of wireless communication. Reference numeral 200 denotes a recording medium such as a memory card or a hard disk.

The recording medium 200 is provided with a storage area 202 constituted by a semiconductor memory, a magnetic disk or the like, an interface 204 with the image processing apparatus 100, and a connector 206 for connecting to the image processing apparatus 100. Reference numeral 210 denotes a recording medium such as a memory card or a hard disk. The recording medium 210 is provided with a storage area 212 constituted by a semiconductor memory, a magnetic disk or the like, an interface 214 with the image processing apparatus 100, and a connector 216 for connecting to the image processing apparatus 100.

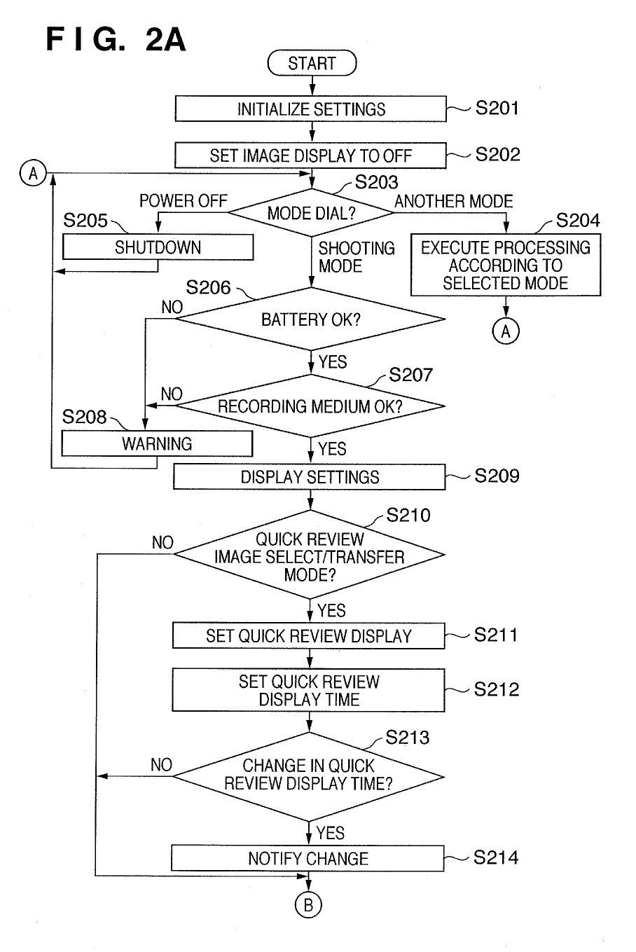

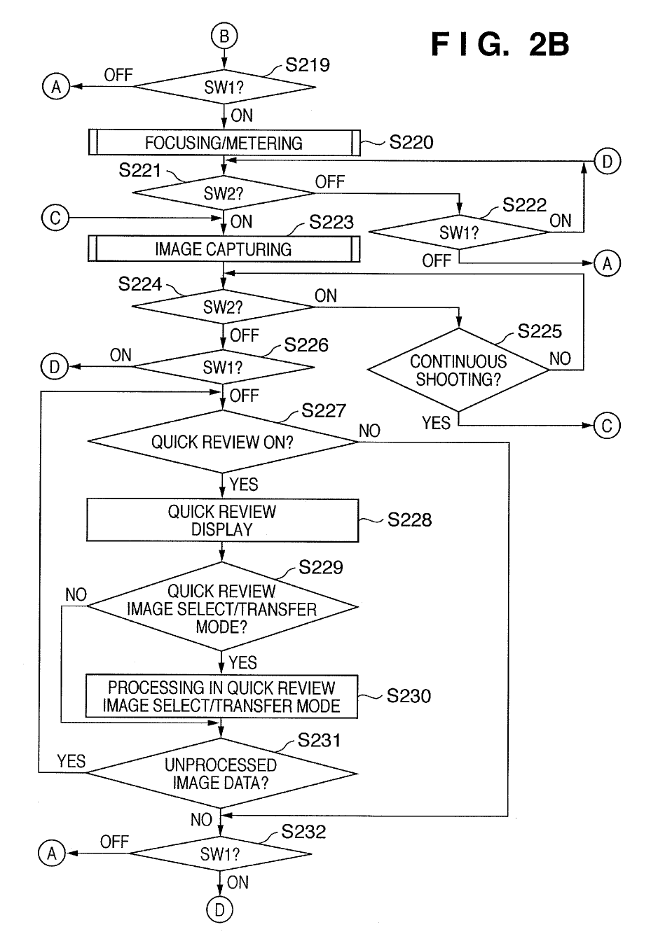

Exemplary operations according to the first embodiment will be described next with reference to FIGS. 2A and 2B. FIGS. 2A and 2B show flowcharts of the main routine of the image processing apparatus 100 according to the present embodiment.

In step S201, an initialization process in which the system controller 50 initializes flags, control variables and the like is performed as a result of the image processing apparatus 100 being powered on after battery replacement or the like. At the subsequent step S202, the system controller 50 sets the image display of the image display unit 28 to off.

In step S203, the system controller 50 determines the set position of the mode dial 60. If the mode dial 60 has been set to off (“POWER OFF” in S203), the processing moves to step S205. If the mode dial 60 has been set to shooting mode (“SHOOTING MODE” in S203), the processing moves to step S206. If the mode dial 60 has been set to another mode (“ANOTHER MODE” in S203), the processing moves to step S204.

In step S204, the system controller 50 executes processing according to the selected mode, and returns to S203 when the processing has ended, where the set position of the mode dial is again determined.

In step S205, the system controller 50 performs a shutdown process. Specifically, the system controller 50 places the display of the display units in a shutdown state, closes the barrier 102 to protect the image capture unit, and records required parameters and settings, including flags and control variables, and set modes, to the nonvolatile memory 56. The system controller 50 uses the power controller 80 to cut off unnecessary power supply to the various components of the image processing apparatus 100 including the image display unit 28. The processing then returns to step S203.

In step S206, the system controller 50 uses the power controller 80 to determine whether the remaining capacity or operating condition of the power supply unit 86 constituted by a battery or the like is adversely affecting the operations of the image processing apparatus 100. If a problem exists (“NO” in step S206), the processing moves to step S208. In step S208, the system controller 50 issues a predetermined visual and/or aural warning using the display unit 54, before returning to step S203.

On the other hand, if no problem exists with the power supply unit 86 (“YES” in step S206), the processing moves to step S207. In step S207, the system controller 50 determines whether the operational state of the recording medium 200 or 210 is adversely affecting the operations of the image processing apparatus 100, particularly the recording/playback of image data on the recording medium. If a problem exists (“NO” in step S207), the processing moves to step S208. In step S208, the system controller 50 issues a predetermined visual and/or aural warning using the display unit 54, before returning to step S203.

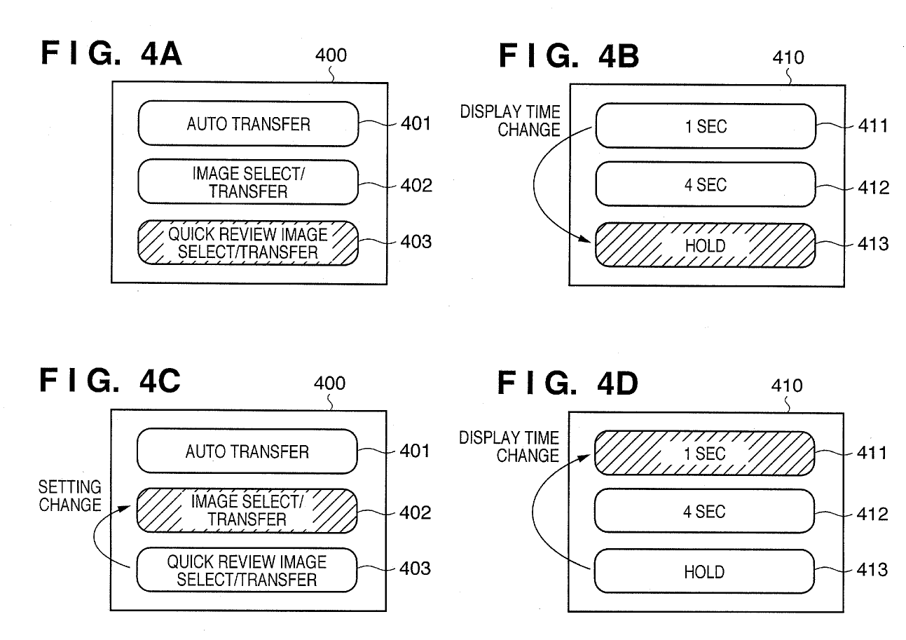

On the other hand, if no problem exists with the operational state of the recording medium 200 or 210 (“YES” in step S207), the processing moves to step S209. In step S209, the system controller 50 visually and/or aurally displays the settings of the image processing apparatus 100 using the display unit 54. Note that if the image display of the image display unit 28 is on, the system controller 50 also uses the image display unit 28 to visually and/or aurally display the settings of the image processing apparatus 100. A screen 400 such as shown in FIG. 4A, for example, is displayed in such a circumstance as a screen for setting the image transfer mode.

The user is able to set the image transfer mode by operating the operation unit 70 when the screen shown in FIGS. 4A and 4C is displayed. At step S210, the system controller 50 determines whether Quick Review Image Select/Transfer mode has been selected here. Note that the following three image transfer modes correspond to the present embodiment.

(1) Auto Transfer mode 401: Images are automatically transferred sequentially during shooting.

(2) Image Select/Transfer mode 402: Images recorded on the recording medium 200 or 210 are displayed on the image display unit 28 after shooting, and only images selected using the image selection button 301 and the selection dial 302 are transferred.

(3) Quick Review Image Select/Transfer mode 403: Captured images are displayed in Quick Review, and the user uses the SET button 300 to select whether to transfer the images.

In Image Select/Transfer mode, images recorded on the recording medium 200 or 210 can be selected for transfer by the frame, by the folder, or the recording medium. In such a circumstance, if images are selected by the folder or by the medium rather than by the frame, images other than those that the user really wants to transfer end up getting targeted for transfer. Also with Auto Transfer mode, images that never needed to be transferred end up getting transferred, since all images are transferred in the order in which they were taken.

If Quick Review Image Select/Transfer mode 403 is selected (“YES” in step S210), the processing moves to step S211. On the other hand, if a mode other than Quick Review Image Select/Transfer mode 403 is selected (“NO” in step S210), the processing moves to step S219.

In step S211, the system controller 50 sets Quick Review display to on if Quick Review is not on. Further, in step S212, the system controller 50 sets the Quick Review display time. In step S213, the system controller 50 judges whether there has been a change in the Quick Review display time. If there has been a change (“YES” in step S213), the processing moves to step S214. If there has not been a change (“NO” in step S213), the processing moves to step S219. According to the present embodiment, the Quick Review display time has been set to “HOLD”, whereby display is continued on the display unit 54 until an operation is performed. In view thereof, the system controller 50 at step S214 uses a screen 410 shown in FIG. 4B to notify the user that there has been a change in the Quick Review display time. In FIG. 4B, the change in the Quick Review display time from the 1 SEC setting 411 to the HOLD setting 413 not to the 4 SEC setting 412 is notified with a flashing display.

Note that, according to the present embodiment, the settings prior to Quick Review being set to on and the settings prior to setting the Quick Review display time to HOLD are saved to the memory 52 while the camera is on. When the camera is powered off, the settings may or may not be saved to the nonvolatile memory 56. Whether or not the settings are saved to the nonvolatile memory 56 depends on whether the user wants to return to the Quick Review setting prior to the image transfer mode being set to Quick Review Image Select/Transfer mode 403, in the event of the image transfer mode being switched from Quick Review Image Select/Transfer mode 403 to another mode when the camera is next powered on.

Note that if the image transfer mode is switched from Quick Review Image Select/Transfer mode 403 to another mode while the camera is on, as shown in FIGS. 4C and 4D, the Quick Review display time returns to the previous setting, based on the settings saved in the memory 52.

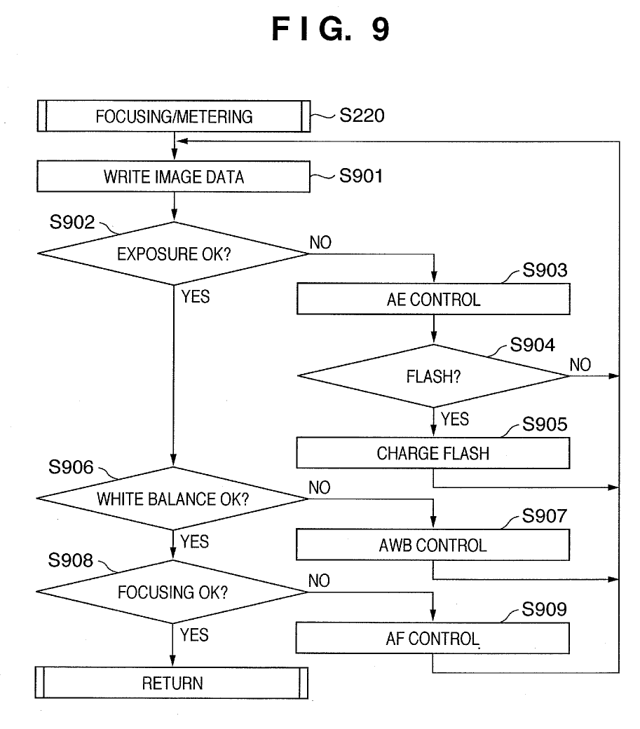

Now referring to FIG. 2b, in step S219, the state of the shutter switch SW1 is determined. If the shutter switch SW1 is not being pressed (“OFF” in step S219), the processing returns to step S203. On the other hand, if the shutter switch SW1 is being pressed (“ON” in step S219), the processing proceeds to step S220. In step S220, the system controller 50 executes focusing and metering, and moves to step S221. Note that the focusing and metering process will be described in detail hereinafter, with reference to FIG. 9.

Next, in step S221, the state of the shutter switch SW2 is determined. If the shutter switch SW2 has not been pressed (“OFF” in step S221), the processing moves to step S222. If the shutter switch SW2 has been pressed (“ON” in step S221), the processing moves to step S223.

In step S222, the system controller 50 again determines the state of the shutter switch SW1. If the shutter switch SW1 has been released (“OFF” in step S222), the processing returns to step S203. On the other hand, if the shutter switch SW1 has not been released (“ON” in step S222), the processing returns to step S221.

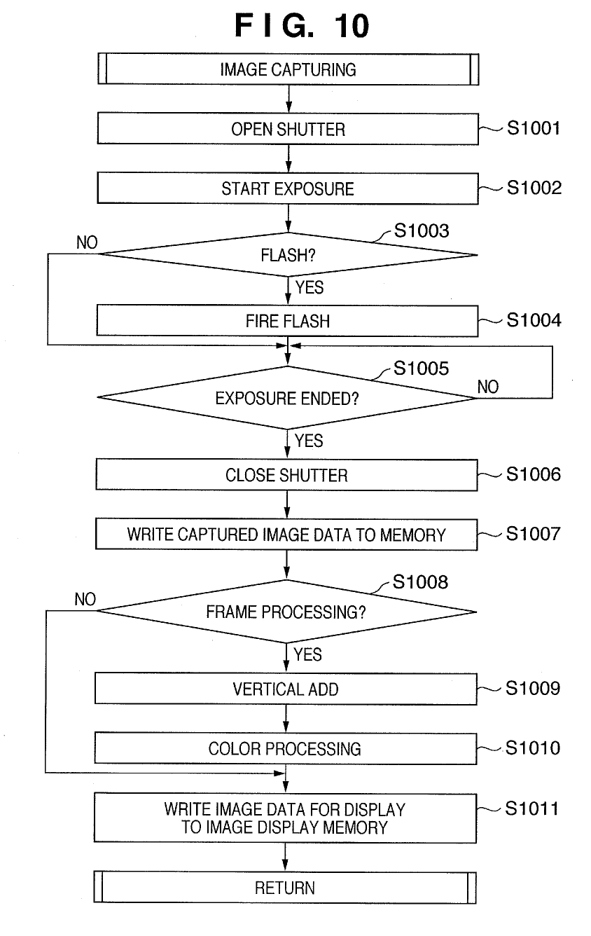

In step S223, the system controller 50 executes image capturing. The image capturing process involves performing an exposure process to write captured image data to the memory 30 via the image capture device 14, the A/D converter 16, the image processing unit 20 and the memory controller 22, or from the A/D converter directly via the memory controller 22, and a developing process to read the image data written to the memory 30 and perform various processing on the read image data using the memory controller 22 and, when necessary, the image processing unit 20. The image capturing process will be described in detail hereinafter, with reference to FIG. 10.

After the image capturing process, the system controller 50 in step S224 determines the state of the shutter switch SW2. If the shutter switch SW2 is being pressed (“ON” in step S224), the processing moves to step S225. In step S225, the system controller 50 determines whether continuous shooting has been set. If continuous shooting has been set (“YES” in step S225), the processing returns to step S223 and the image capturing process is repeated. On the other hand, if continuous shooting has not been set (“NO” in step S225), the processing returns to step S224, and the processing to determine the state of the shutter switch SW2 is continued until the shutter switch SW2 is turned off.

If the shutter switch SW2 has been turned off (“OFF” in step S224), the processing moves to step S226. In step S226, the system controller 50 determines the state of the shutter switch SW1. If the shutter switch SW1 is not being pressed (“OFF” in step S226), the processing moves to step S227. On the other hand, if the shutter switch SW1 is being pressed (“ON” in step S226), the processing moves to step S221.

In step S227, the system controller 50 determines whether Quick Review is set to on. If Quick Review is set to on (“YES” in step S227), the processing moves to step S228. On the other hand, if Quick Review is set to off (“NO” in step S227), the processing moves to step S232.

In step S228, the system controller 50 displays the captured image in Quick Review using the display unit 54. In the subsequent step S229, the system controller 50 determines whether the image transfer mode is set to Quick Review Image Select/Transfer mode 403. If Quick Review Image Select/Transfer mode is not set (“NO” in step S229), the processing moves to step S231.

If Quick Review Image Select/Transfer mode is set (“YES” in step S229), the processing moves to step S230. In step S230, the system controller 50 performs the processing in Quick Review Image Select/Transfer mode, and moves to step S231. The processing in Quick Review Image Select/Transfer mode will be described in detail below with reference to FIG. 3 and FIGS. 5A through 8B, as well as specific examples of Quick Review display.

Next, in step S231, the system controller 50 determines whether there is unprocessed image data. If there is unprocessed image data (“YES” in step S231), the processing returns to step S227. On the other hand, if there is no unprocessed data (“NO” in step S231), the processing moves to step S232. In step S232, the system controller 50 determines the state of the shutter switch SW1. If the shutter switch SW1 is being pressed (“ON” in step S232), the system controller 50 returns to step S221 and prepares for the next shot. On the other hand, if the shutter switch SW1 is not being pressed (“OFF” in step S232), the system controller 50 ends the series of image capturing operations and returns to step S203.

Hereinafter, the processing in the above steps S229 and S230 will be described, with reference to FIG. 3 and FIGS. 5A through 8B.

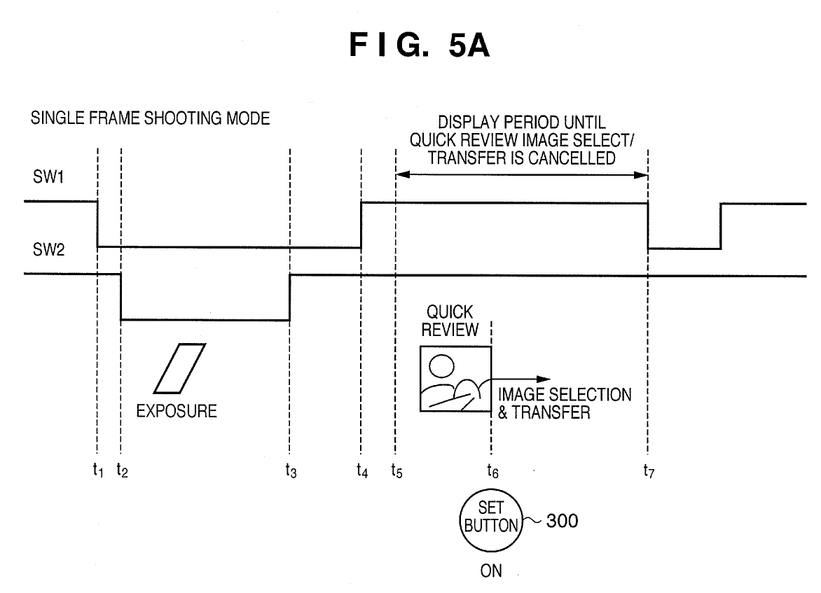

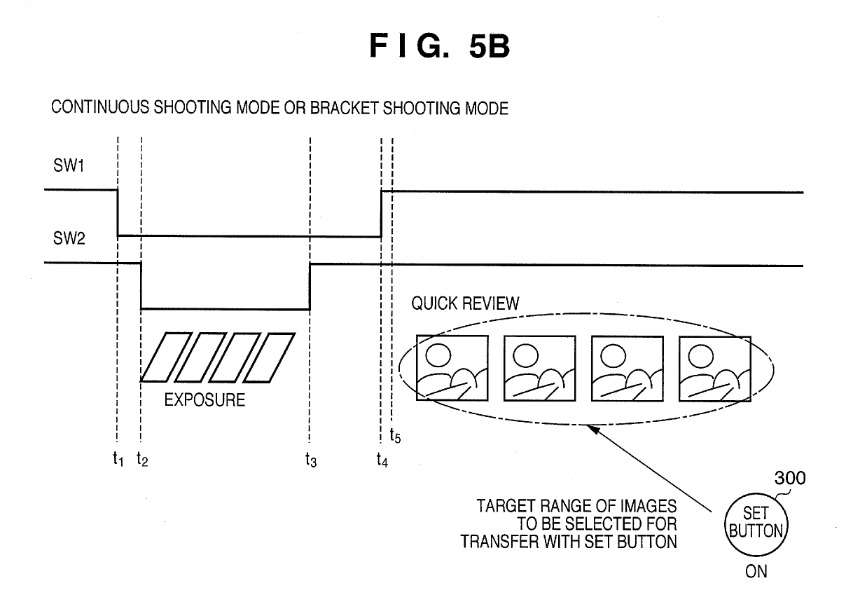

First, FIG. 5A shows the processing in single frame shooting mode, while FIG. 5B shows the processing in continuous shooting mode or bracket shooting mode. According to the present embodiment, as shown in the flowcharts of FIGS. 2A and 2B, image capturing is performed under the control of the system controller 50 using the shutter switches SW1 (62) and SW2 (64). In FIGS. 5A and 5B, the on and off states of the shutter switch operations of SW1 and SW2 are shown respectively by the low and high lines. Quick Review display is performed when SW1 is off, and disappears when SW1 is turned on.

In FIG. 5A, SW1 is turned on at time t1, and exposure is performed when SW2 is turned on at time t2. Then, SW2 is turned off at time t3, and the system controller 50 checks the state of the Quick Review flag when SW1 is turned off at time t4, and performs Quick Review display on the display unit 54 from time t5 when the flag is on.

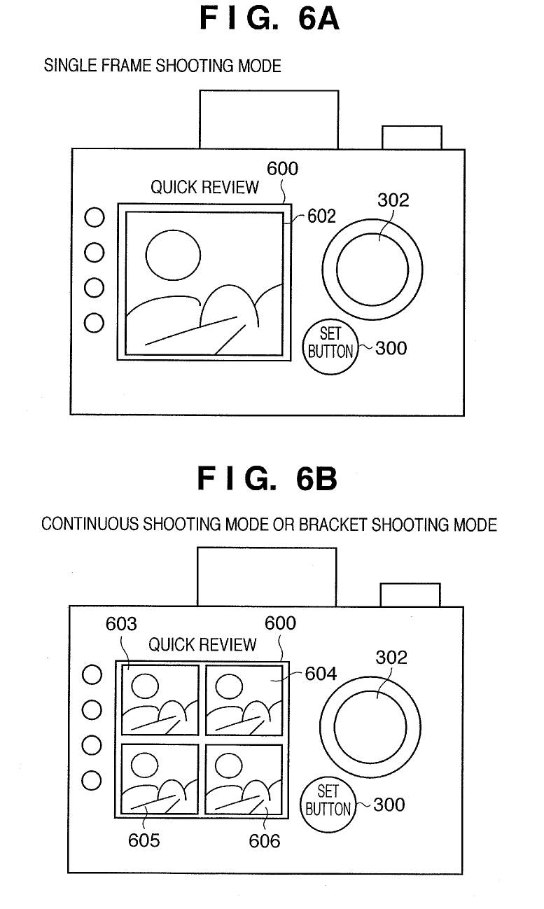

Exemplary Quick Review display in the case of single frame shooting mode is shown in FIG. 6A. In FIG. 6A, the Quick Review display of image data 602 captured in single frame shooting mode is performed in single frame display format on a screen 600 corresponding to the display unit 54. The displayed image is selected for transfer when the SET button 300 is operated (on) in the present display state, enabling the selected image to be transferred from the communication unit 110 to an external personal computer or a network hard drive. Note that the selection dial 302 is used for switching the selected image in continuous shooting mode and bracket shooting mode. On the other hand, if the user does not want to transfer the image, Quick Review display can be ended by turning on SW1.

In FIG. 5A, the period after t5 during which SW1 is off is when an image can either be selected or deselected for transfer. SW1 is turned on at time t7 in FIG. 5A. The image displayed in Quick Review on the screen 600 up till such a point in time is thereby deselected for transfer. If the SET button 300 is pressed at time t6, the image displayed in Quick Review at that time is selected for transfer and processing to transfer the selected image is performed.

If the shutter switch SW1 is operated between times t4 and t5 to capture images sequentially in single frame shooting mode, the operation of SW1 is perceived as a normal shutter operation. Plural pieces of image data are generated when a plurality of images are thus taken sequentially in single frame shooting mode. Assume, for example, that five images were taken in single frame shooting mode. If five images are taken by operating the shutter switch SW1 before time t5, there is no time to display the captured images in Quick Review, and consequently no time to select images for transfer. Data of images that have not been displayed in Quick Review and thus have not undergone selection for transfer are displayed in Quick Review after t5 once SW1 has been turned off.

Quick Review is performed starting with the first image captured out of the plurality of images that have not been displayed in Quick Review. The first image displayed is selected or deselected for transfer by pressing the SET button 300 or the shutter switch SW1. When the process ends, the second image is displayed in Quick Review, and either selected or deselected as the image data for transfer. Similar processing is performed on the third image onwards.

Selection of images for transfer can thus be performed collectively on images taken sequentially in single frame shooting mode.

If the shooting mode is set to continuous shooting mode or bracket shooting mode, on the other hand, processing is not performed per frame as with single frame shooting mode, but by the number of images taken sequentially while SW2 is being pressed, or by the number of bracketed images taken. In the case of continuous shooting mode or bracket shooting mode, Quick Review display switches from single frame display to multi-frame display when Quick Review Image Select/Transfer mode is selected. With multi-frame display, display is performed for the number of images taken sequentially at one time, or the number of bracketed images taken.

In FIG. 5B, SW1 is turned on at time t1, and exposure corresponding to the number of sequential images is performed when SW2 is turned on at time t2. Then, SW2 is turned off at time t3, and the system controller 50 checks the state of the Quick Review flag when SW1 is turned off at time t4, and performs Quick Review display on the display unit 54 from time t5 when the flag is on.

For example, consider the case where four sequential images are taken the first time, four the second time, and six the third time. In the case where plural frames of image data are generated sequentially in a single image capturing process, the user selects or deselects images for transfer by pushing the SET button 300 or the shutter switch SW1, with the image data of four frames as the selection range of one piece of transfer image data in the above example.

That is, when four images are taken sequentially, as shown in FIG. 5B, the four images are displayed in Quick Review from time t5 after SW1 has been released at time t4. An exemplary display of such a circumstance is shown in FIG. 6B. In FIG. 6B, the sequentially captured pieces of image data 603 to 606 are displayed in Quick Review on the screen 600 corresponding to the display unit 54. When the SET button 300 is operated (on) in the present display state, the displayed images 603 to 606 can be selected for transfer with four frames as a single selection range.

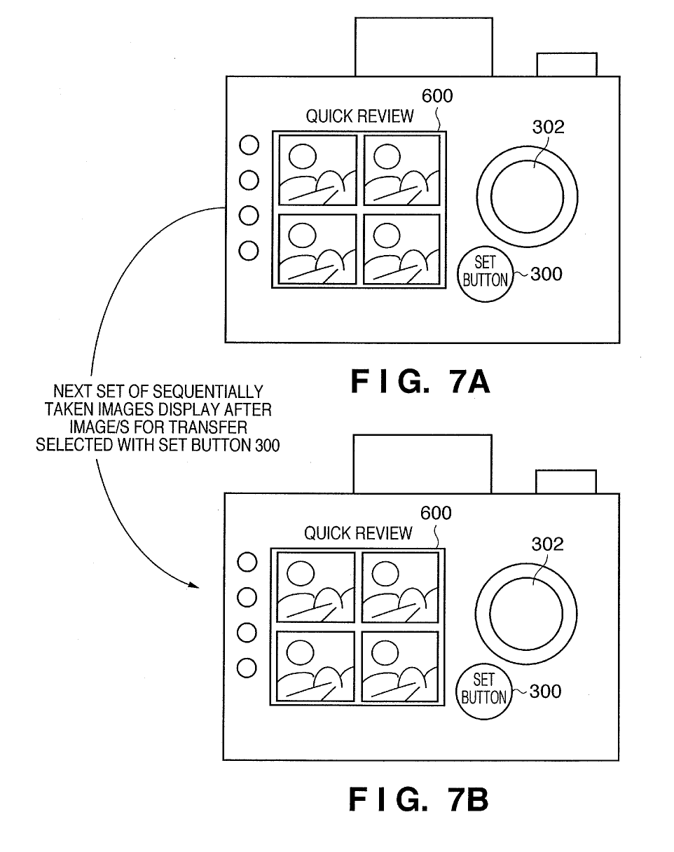

It is also possible in continuous shooting mode or bracket shooting mode to take further sequential images by operating the shutter switch SW1 before time t5 in FIG. 5B, which is when Quick Review is performed. In such a circumstance, the captured images are displayed collectively at a later time. Once the selection process for the first set of four frames of images has ended, the screen changes as shown in FIGS. 7A and 7B, and the selection process is performed with the image data of the next four frames as the selection range of one piece of transfer image data. Finally, the selection process is performed with the image data for six frames as one piece of transfer image data, and the transfer process in Quick Review Image Select/Transfer mode is performed on all of the selected image data.

Note that in the above description, the Quick Review display in FIGS. 6A and 6B are also used as the display screen for image selection, although an image data display mode for use in Quick Review Image Select/Transfer mode may be provided.

Also, a case is probable in which two, three, five and seven images as taken in bracket shooting mode. In consideration thereof, the Quick Review screen when bracket shooting is performed can be divided in four when two to three images are taken, and divided in nine when five to seven images are taken. The number of frames into which the screen is divided is changed in response to operation of the SET button 300 or the shutter switch SW1 if the image data for transfer exceeding the number of images that can be displayed at one time is included in the selection range.

Next, exemplary processing to select images for transfer from plural pieces of image data in the case of multi-shot modes such as continuous shooting mode and bracket shooting mode will be described, with reference to FIGS. 8A and 8B.

FIG. 8A shows an example in which Quick Review display after shooting in continuous shooting mode is displayed on the screen 600 using a multi-frame display divided in four. Here, the four images 801 to 804 are displayed.

In the display state shown in FIG. 8A, the system controller 50 determines that there are no images for transfer if SW1 is turned on, and either displays the next set of sequential images on the screen 600 or ends the Quick Review display. On the other hand, if the SET button 300 is operated, the set of displayed sequential images 801 to 804 is selected for transfer, and the transfer process is performed on the images thus displayed.

According to the present embodiment, the image selection button 301 and the selection dial 302 can be used to select for transfer only the images that the user has selected out of the sequentially captured images. Firstly, if the image selection button 301 is operated when in Quick Review Image Select/Transfer mode, it becomes possible to select images for transfer from the plurality of images displayed on the screen 600. Specifically, a frame 805 is displayed around one of the images on the screen 600 if the image selection button 301 is operated when in Quick Review Image Select/Transfer mode. Having confirmed the display of the frame 805, the user can then move the displayed position of the frame 805 by rotating the selection dial 302 as shown in FIG. 8B. The image around which the frame 805 is positioned is selected for transfer by operating the SET button 300 when the frame is in a desired position.

For example, if the SET button 300 is operated with the frame 805 positioned around the image 801, as shown in FIG. 8B, the image 801 is selected for transfer. Then, by moving the frame 805 and operating the SET button 300 with the frame 805 positioned around the image 804, for example, the image 804 is also selected for transfer.

If the image selection button 301 is operated again with the frame 805 displayed as shown in FIG. 8B, the frame 805 disappears, disabling the mode for selecting individual images for transfer from the plurality of images displayed on the screen 600. If the SET button 300 is operated in such a state, the selection of images for transfer using the image selection button 301 and the selection dial 302 is canceled, and the images currently displayed on the screen 600 are all selected for transfer. On the other hand, to switch to the next set of sequential images after having selected individual images from one set of images, the user operates SW1. The set of images displayed in Quick Review thereby changes.

To summarize the above, the processing in Quick Review Image Select/Transfer mode will be described with reference to the flowchart in FIG. 3.

In FIG. 3, the system controller 50 in step S301 determines whether the shooting mode is set to single frame shooting mode. If set to single frame shooting mode (“YES” in step S301), the processing moves to step S302. On the other hand, if the shooting mode is set to continuous shooting mode or bracket shooting mode (“NO” in step S301), the processing moves to step S306.

In step S302, the system controller 50 displays the captured image in Quick Review on the screen 600, using single frame display. An exemplary display thereof is shown in FIG. 6A. In the present display state, the system controller 50 in step S303 determines whether to a button operation has been accepted. If operation of the shutter switch SW1 has been accepted (“SW1” in step S303), the system controller 50 ends the subroutine.

On the other hand, if operation of the SET button 300 has been accepted (“SET BUTTON 300” in step S303), the processing moves to step S304. In step S304, the system controller 50 selects the image displayed on the screen 600 for transfer. At the subsequent step S305, the system controller 50 transfers the selected image. The system controller 50 then ends the subroutine.

In step S306, the system controller 50 displays the captured images in Quick Review on the screen 600, using multi-frame display. In this display state, the system controller 50 in step S307 determines whether a button operation has been accepted. If operation of the shutter switch SW1 has been accepted (“SW1” in step S307), the system controller 50 ends this subroutine.

On the other hand, if operation of the SET button 300 has been accepted (“SET BUTTON 300” in step S307), the processing moves to step S304. In step S304, the system controller 50 selects the plurality of images displayed on the screen 600 for transfer. In the subsequent step S305, the system controller 50 transfers the selected images. The system controller 50 then ends the subroutine.

Further, if operation of the image selection button 301 has been accepted (“IMAGE SELECTION BUTTON 301” in step S307), the processing moves to step S308. In step S308, the system controller 50 accepts selection of images for transfer from the plurality of images displayed on the screen 600, based on operation of the selection dial 302 and the SET button 300. In the subsequent step S309, the system controller 50 transfers the images selected for transfer. Further, in step S310, the system controller 50 determines whether the image selection button 301 has been operated. If determined that the image selection button 301 has been operated (“YES” in step S310), the processing returns to step S306. If determined that the image selection button 301 has not been operated (“NO” in step S310), the processing returns to step S308 and is continued.

Next, the focusing and metering process of step S220 in FIG. 2B will be described in detail with reference to FIG. 9.

In step S901, the system controller 50 reads the charge signal from the image capture device 14, and sequentially reads the captured image data to the image processing unit 20 via the A/D converter 16. The image processing unit 20 uses the sequentially read image data to perform predetermined arithmetic processing used in the through-the-lens (TTL) auto exposure (AE), electronic flash pre-emission (EF), and auto focus (AF).

Note that in each of these processes, a specific portion of the total pixels constituting a captured image is extracted according to necessity and used in the arithmetic processing. In the TTL AE, EF, AWB and AF processes, optimal arithmetic processing can thereby be performed for each of the different metering modes, including center-weighted mode, average mode, and evaluative mode.

In step S902, the system controller 50 determines whether the exposure (AE) is appropriate, using the results of the arithmetic processing performed by the image processing unit 20. If determined to not be appropriate (“NO” in step S902), the processing moves to step S903, where AE control is performed using the exposure controller 40. AE control is thereby performed until the exposure is determined to be appropriate. In the subsequent step S904, the system controller 50 determines whether flash is required, using the measured data obtained in the AE control of step S903. If determined that flash is required (“YES” in step S904), the processing moves to step S905, where the flash flag is set and the flash 48 is charged. On the other hand, if determined that flash is not required (“NO” in step S904), the processing returns to step S901 and is continued.

If determined in step S902 that the exposure (AE) is appropriate (“YES” in step S902), the system controller 50 stores the measured data and/or the set parameters in an internal memory of the system controller 50 or in the memory 52.

In the subsequent step S906, the system controller 50 determines whether the white balance (AWB) is appropriate, using the results of the arithmetic processing performed by the image processing unit 20 and the measured data obtained in the AE control. If determined to not be appropriate (“NO” in step S906), the processing moves to step S907. In step S907, AWB control is performed by adjusting the color processing parameters using the image processing unit 20, after which the processing returns to step S901. The AWB control is thereby performed until the white balance is determined to be appropriate.

If determined that the white balance (AWB) is appropriate (“YES” in step S906), the system controller 50 stores the measured data and/or the set parameters in an internal memory of the system controller 50 or in the memory 52. Then, the system controller 50 in step S908 determines whether the subject is focused (AF), using the measured data obtained in the AE control and the AWB control. If determined that the subject is focused (“YES” in step S908), the system controller 50 stores the measured data and/or the set parameters in an internal memory of the system controller 50 or in the memory 52 and ends the focusing and metering process.

On the other hand, if determined that the subject is not focused (“NO” in step S908), the processing moves to step S909. In step S909, AF control is performed using the focusing controller 42. The AF control is thereby performed until the subject is focused.

Next, the image capturing process of S223 in FIG. 2B will be described in detail with reference to FIG. 10.

Firstly, in step S1001, the system controller 50 uses the exposure controller 40 to open the shutter 12 having the aperture function according to the aperture value, in accordance with the metering data stored in an internal memory of the system controller 50 or in the memory 52. Exposure of the image capture device 14 is thereby started in step S1002.

In step S1003, the system controller 50 determines whether the flash 48 is required depending on the flash flag. If determined that the flash 48 is required (“YES” in step S1003), the processing moves to step S1004, where the flash is fired. On the other hand, if determined that the flash 48 is not required (“NO” in step S1003), the processing moves to step S1005.

In step S1005, the system controller 50 determines whether exposure of the image capture device 14 in accordance with the measured data has ended. If exposure has ended (“YES” in step S1005), the processing moves to step S1006, where the shutter 12 is closed. In the subsequent step S1007, the system controller 50 reads the charge signal from the image capture device 14, and writes the captured image data to the memory 30 via the A/D converter 16, the image processing unit 20 and the memory controller 22 or from the A/D converter 16 directly via the memory controller 22.

At step S1008, the system controller 50 determines whether frame processing is required, according to the set shooting mode. If frame processing is required (“YES” in step S1008), the processing moves to step S1009. If frame processing is not required (“NO” in step S1008), the processing moves to step S1011. The system controller 50 in step S1009 reads the image data written to the memory 30 and performs a Vertical ADD operation, using the memory controller 22 and, if necessary, the image processing unit 20. The system controller 50 further performs color processing in step S1010. The processed image data is written to the memory 30.

In step S1011, the system controller 50 reads image data for display from the memory 30, and writes the read image data to the image display memory 24 via the memory controller 22. Once the series of processing has ended, the system controller 50 ends the image capturing process.

As can be readily seen from the above description, the present invention enables images that the user wants to transfer to a personal computer or the like that is communicably connected to the camera to be selected from displayed images using button operations and shutter switches.

With regard to the selection of image data for transfer using button operations and shutter switches, the number of pieces of image data that can be processed at one time in selecting image data for transfer and transferring the same can be changed according to whether the shooting mode is set to single frame shooting, continuous shooting or bracket shooting.

Further, image display after shooting in the case of single frame shooting mode and image display after shooting in the case of continuous shooting mode or bracket shooting mode can be switched between single frame display and multi-frame display. Further, displayed images can be collectively selected for transfer in the image display. Moreover, with multi-frame display, it is possible to select images for transfer from the images displayed using multi-frame display, and to only transfer those images selected as the image data for transfer.

When the image transfer mode is set to Quick Review Image Select/Transfer mode, the operation to select and transfer only image data that the user really wants to transfer to an external device out of captured images can be performed in coordination with the shooting operation. Also, organizing image data at the transfer destination is facilitated, together with improving transfer efficiency, because of being able to prevent the transfer of unnecessary image data such as botched images, while at the same time being able to take shots and select and transfer images without missing photo opportunities. Also, since communication channels can be effectively utilized, someone operating an external apparatus to which image data is transferred can quickly check captured image data.

### Additional Exemplary Embodiments

Note that the present invention may be applied to a system constituted by a plurality of devices (e.g., host computer, interface device, reader, printer), or to an apparatus composed of a single device (e.g., copier, facsimile).

The present invention may also be achieved by supplying a storage medium having the program code of software for realizing the aforementioned functions recorded thereon to a system, which then reads and executes the program code. In this case, the program code read from the storage medium itself realizes the functions of aforementioned embodiment, and the storage medium storing the program code constitutes the present invention. Also included is the case where an operating system (OS) or the like running on a computer performs part or all of the actual processing based on instructions in the program code, and the aforementioned functions are realized as a result of this processing.

Further, the aforementioned functions may be realized with the following configuration. That is, the program code read from the storage medium is written to a memory provided in a function expansion card inserted in a computer or a function expansion unit connected to a computer. A CPU or the like provided in the function expansion card or function expansion unit then performs part or all of the actual processing based on instructions in the program code, and the aforementioned functions are realized as a result of this processing.

In the case where the present invention is applied to the storage medium, program code corresponding to the flowcharts described above is stored in the storage medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-257736, filed Sep. 22, 2006, which is hereby incorporated by reference herein in its entirety.

What is claimed is:

1. An image processing apparatus comprising:
an image capture unit configured to execute image capturing in response to an image shooting instruction;
a display unit configured to display an image obtained by the image capturing unit;
a transfer instruction acceptance unit configured to accept a transfer instruction to transfer the image to an external apparatus;
a communication unit configured to transfer an image subject to the transfer instruction to the external apparatus; and
a display control unit configured to control display by the display unit, that, if acceptance of the transfer instruction by the transfer instruction acceptance unit is possible during display of the image by the display unit, controls the display unit so as to continue displaying the image until the transfer instruction is accepted.

2. The image processing apparatus according to claim 1, wherein display of the image by the display unit is performed immediately after the image capturing by the image capture unit.

3. The image processing apparatus according to claim 2, further comprising:
an image shooting instruction acceptance unit configured to accept operation of the image shooting instruction, wherein
the image capture unit executes the image capturing if operation of the image shooting instruction is accepted by the image shooting instruction acceptance unit, and
the display immediately after the image capturing is performed in response to operation of the image shooting instruction being released.

4. The image processing apparatus according to claim 1, further comprising:
an operation setting acceptance unit configured to accept an operation setting to make possible acceptance by the transfer instruction acceptance unit of the transfer instruction to the external apparatus during display of the image by the display unit, wherein
if the operation setting is accepted, the display control unit controls the display unit so as to continue displaying the image until the transfer instruction is accepted.

5. The image processing apparatus according to claim 1, further comprising:
a first selection unit configured to accept an operation for deselecting the image displayed by the display unit as a target for transfer to the external apparatus, wherein
the display control unit controls the display unit so as to continue displaying the image until whichever of the transfer instruction and the operation on the first selection unit is accepted first.

6. The image processing apparatus according to claim 5, wherein
the first selection unit is the same operation unit as the image shooting instruction acceptance unit,
if an operation on the operation unit is accepted when the image is not displayed by the display unit, the operation is accepted as the operation on the image shooting instruction acceptance unit, and
if an operation on the operation unit is accepted when the image is displayed by the display unit, the operation is accepted as the operation on the first selection unit.

7. The image processing apparatus according to claim 1, wherein the display control unit causes the display unit to display an image obtained as a result of image capturing executed by the image capture unit in response to a single image shooting instruction.

8. The image processing apparatus according to claim 7, wherein
if a single image is obtained as a result of the image capturing executed by the image capture unit in response to the single image shooting instruction, the display control unit causes the display unit to display the single image, and
if a plurality of images are obtained as a result of the image capturing executed by the image capture unit in response to the single image shooting instruction, the display control unit causes the display unit to display the plurality of images together.

9. The image processing apparatus according to claim 8, further comprising:
a second selection unit configured for selecting, from the plurality of images if the plurality of images are displayed by the display unit, an image to be transferred to the external apparatus,
wherein the communication unit transfers the image selected by the second selection unit to the external apparatus.

10. The image processing apparatus according to claim 1, wherein
if operation of a further image shooting instruction is performed before a first image obtained by the image capturing is displayed by the display unit, the display control unit suppresses display of the first image, and
in response to operation of the further image shooting instruction being released, the display control unit causes the display unit to display the first image prior to a second image obtained by the image capturing executed in response to the further image shooting instruction.

11. A control method for an image processing apparatus, the method comprising:
image capturing of using an image capture unit to execute image capturing in response to an image shooting instruction;
displaying the image obtained by the image capturing, using a display unit;
accepting a transfer instruction to transfer the image to an external apparatus; and
transferring an image subject to the transfer instruction to the external apparatus, using a communication unit,
wherein if acceptance of the transfer instruction is possible during display of the image by the display unit, display of the image in the displaying step is continued until the transfer instruction is accepted.

12. The control method according to claim 11, wherein display of the image in the displaying step is performed immediately after the image capturing by the image capture unit.

13. The control method according to claim 12, further comprising:
accepting operation of the image shooting instruction, using an image shooting instruction acceptance unit,
wherein in the image capturing step, image capturing is executed if operation of the image shooting instruction is accepted by the image shooting instruction acceptance unit, and
display immediately after the image capturing is performed in response to operation of the image shooting instruction being released.

14. The control method according to claim 11, further comprising:
accepting an operation setting to make possible acceptance of the transfer instruction to the external apparatus during display of the image by the display unit,
wherein if the operation setting is accepted, display of the image is continued until the transfer instruction is accepted.

15. The control method according to claim 11, further comprising:
accepting an operation on a first selection unit for deselecting the image displayed by the display unit as a target for transfer to the external apparatus,
wherein display by the display unit in the displaying step is continued until whichever of the transfer instruction and the operation on the first selection unit is accepted first.

16. The control method according to claim 15, wherein
the first selection unit is the same operation unit as the image shooting instruction acceptance unit configured to accept the operation of the image shooting instruction,
if an operation on the operation unit is accepted when the image obtained by the image capturing is not displayed by the display unit, the operation is accepted as the operation on the image shooting instruction acceptance unit, and
if an operation on the operation unit is accepted when the image obtained by the image capturing is displayed by the display unit, the operation is accepted as the operation on the first selection unit.

17. The control method according to claim 11, wherein in the displaying step, an image obtained in response to a single image shooting instruction is displayed by the display unit.

18. The control method according to claim 17, wherein in the displaying step,
if a single image is obtained as a result of the image capturing executed by the image capture unit in response to the single image shooting instruction, the single image is displayed by the display unit, and
if a plurality of images are obtained as a result of the image capturing executed by the image capture unit in response to the single image shooting instruction, the plurality of images are displayed together by the display unit.

19. The control method according to claim 18, further comprising:
selecting, from the plurality of images if the plurality of images are displayed by the display unit, an image to be transferred to the external apparatus,
wherein in the transferring step, the image selected in the selecting step is transferred to the external apparatus.

20. The control method according to claim 11, wherein in the displaying step,
if operation of a further image shooting instruction is performed before a first image obtained by the image capturing is displayed by the display unit, display of the first image is suppressed, and
in response to operation of the further image shooting instruction being released, the first image is displayed by the display unit prior to a second image obtained by the image capturing executed in response to the further image shooting instruction.

21. A computer program that is stored on a computer readable storage medium and causes a computer to function as an image processing apparatus provided with an image capture unit, display unit, transfer acceptance unit, communication unit, and display control unit; the program comprising:
computer-executable instructions for executing image capturing in response to an image shooting instruction;
computer-executable instructions for displaying an image obtained by the image capturing unit;
computer-executable instructions for accepting a transfer instruction to transfer the image to an external apparatus;
computer-executable instructions for transferring an image subject to the transfer instruction to the external apparatus; and
computer-executable instructions for controlling display by the display unit, that, if acceptance of the transfer instruction by the transfer instruction acceptance unit is possible during display of the image by the display unit, controls the display unit so as to continue displaying the image until the transfer instruction is accepted.

22. An image capture apparatus comprising:
an image capture unit configured to execute image capturing;
a display unit configured to display an image obtained by the image capturing;
a setting unit configured to set a display time for every images obtained by the image capturing;
a communication unit configured to transfer the image obtained by the image capturing to an external apparatus; and
a display control unit configured to control display by the display unit so as to continue displaying the image until a following operation is accepted by ignoring the display time set by the setting unit, if it had been instructed to confirm the image to be transferred before transferring.

23. A control method for an image capture apparatus, the method comprising:
image capturing by an image capture unit;
displaying an image obtained by the image capturing by a display unit;
setting a display time for every images obtained by the image capturing;
transferring the image obtained by the image capturing to an external apparatus; and
controlling display by the display unit so as to continue displaying the image until a following operation is accepted by ignoring the set display time, if it had been instructed to confirm the image to be transferred before transferring.

24. A computer program that is stored on a computer readable storage medium and causes a computer to function as an image capture apparatus provided with an image capture unit, display unit, setting unit, communication unit, display control unit; the program comprising:
computer-executable instructions for executing image capturing;
computer-executable instructions for displaying an image obtained by the image capturing;
computer-executable instructions for setting a display time for every images obtained by the image capturing;
computer-executable instructions for transferring the image obtained by the image capturing to an external apparatus; and
computer-executable instructions for controlling display by the display unit so as to continue displaying the image until a following operation is accepted by ignoring the display time set by the setting unit, if it had been instructed to confirm the image to be transferred before transferring.
